(19) United States
(12) Patent Application Publication
(10) Pub. No.: US 2009/0056751 A1
(43) Pub. Date: Mar. 5, 2009

(54) CLEANING STORAGE AND LIKE TANKS

(76) Inventor: Keith Roscoe, Cheshire (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/914,911

(22) PCT Filed: May 17, 2006
(86) PCT No.: PCT/GB2006/001797

§ 371 Date: Sep. 12, 2008

(30) Foreign Application Priority Data
May 17, 2005 (GB) 0509971.8

(51) Int. Cl. B08B 9/093; B08B 9/00; B08B 3/08; B08B 5/02

(52) U.S. Cl. 134/7; 15/406; 134/22.18; 134/22.17; 134/18

(57) ABSTRACT

A method for cleaning the interior walls of a storage tank comprises traversing over said walls a cleaning head supplied with air. The cleaning head may comprise a cleaning duct having an inlet and an outlet and a lateral opening which in use is sealingly arranged against the tank wall, whereby air flowing through the duct flows over and in contact with the tank wall. Cleaning materials, such as aggregate particles and cleaning fluid droplets, may be entrained in the air.

This invention relates to cleaning the interiors of storage and like tanks, especially, but not exclusively, large storage tanks such as are used for storing oil and petrochemical products, water, chemicals, foodstuffs, liquid or solid, and many other materials.

Such tanks are usually circular in plan view, and often have a conical base section with a lowermost outlet, and the invention will be described more specifically in relation to such tanks, but it will be understood that the technology herein disclosed can readily be adapted to other tanks and vessels, such, for example, as tanks which are polygonal, for example, octagonal or square in plan view and tanks which are flat bottomed.

Currently, methods used for tank cleaning very much depend on the size and shape of the tank, the manner in which the interior can be accessed, the product stored in the tank, and the degree of cleanliness required. Most often, cleaning is a matter of manual washing, scrubbing, stem cleaning, chipping away solid deposits and the use of substantial quantities of detergents and/or organic solvents, even, sometimes, harsh acid or caustic cleansers. The methods are time consuming and labour intensive, without any guarantee of thoroughness, and environmentally unfriendly. Downtime is costly, as very often a cleaning operation will require a total or at least partial plant shutdown.

The present invention provides methods and apparatus for tank cleaning that are capable of automatic operation, without any manual presence inside the tank, and which are quick, efficient and thorough, and which use comparatively small amounts, if, indeed, any, of washing water, detergents, solvents and other chemical cleansers.

The invention comprises, in one aspect, a method for cleaning the interior walls of a storage tank, comprising traversing over said walls a cleaning head supplied with air.

The cleaning head may comprise a cleaning duct having an inlet and an outlet and a lateral opening which in use is sealingly arranged against the tank wall, whereby air flowing through the duct flows over and in contact with the tank wall.

The air may be supplied to the cleaning head at different pressures and flow rates. Generally speaking, air may be supplied at a high flow rate, say 5-100 m/s, which will usually strip most loose material, even viscous liquid or paste or cream materials from the tank wall.

However, cleansing materials may be carried in the airflow to assist in the removal of more stubborn deposits. Such cleansing materials may include liquids in the form of droplets, such as water, which may contain a detergent and/or other additives such as disinfectant and antifungal agents, and solid particulate material, which will be effective against scale and other solid wall deposits. Such solid particulate material may comprise flint or other stone aggregate, iron shot, glass or plastics material beads or blasting sand.

The airflow may be swirled at the inlet to the cleaning duct, whereby to have the effect of throwing the cleansing materials into contact with the tank wall.

The entire tank wall area may, in one mode of operation, be traversed several times, each time deploying one phase of the cleaning process. Thus, the cleaning head may be traversed over the entire wall surface, in a first pass, with just air flowing at high speed, stripping off whatever wall deposit it may. Then, a second pass may be made of the entire wall surface, this time with a cleansing material entrained in the air stream. If there is solid wall deposit, e.g. limescale, the cleansing material could be a solid particulate material. A third phase would involve the use of liquid cleansers such as water with detergent. As this will leave the tank wall wet, it may then be desired to dry the wall, which may be done by again passing dry air through the cleaning head, which air may be heated, as by a electric resistance heating, or by adiabatic heating by throttling back the outlet from a blower supplying the air, or by throttling back the outlet of the cleaning head duct, whereby to increase pressure, and hence temperature.

In another mode of operation, the cleaning head may make only one pass over the tank wall, pausing at each wall section covered by the cleaning duct lateral opening, and carrying out all, or as many as may be desired, of the operations of air stripping, solid particulate material scale removal, liquid droplet cleansing and drying before moving on to another wall section.

Other modes of operation may be hybrids of the two above described, for example, the second mode may be carried out with the exception of the drying stage, then another sweep may be made with a dry and/or heated airflow. Or the second mode may be carried out up to and including scale removal by solid particulate material, and then the entire wall washed and dried in another pass.

The entire operation, or one or more sections of it, may be effected automatically, or under the control of a process controller, which may carry out different parts of the operation on a sequential, timed, basis, or which may be programmed to respond to sensor means detecting when any particular stage of the operation is completed. Thus, the completion of scale removal may be indicated by a sensor detecting a cessation of fine scale dust in the airflow, and completion of drying may be indicated by a relative humidity sensor.

The way in which the cleaning head is traversed, and even the size and configuration of the leaning head, will depend upon the size and configuration of the tank. In an open top, circular-cylindrical tank with a conical base having a central, lowermost outlet, a possible configuration of cleaning head would be a cylindrical duct disposed against the tank wall, axially parallel thereto and sealed thereagainst by flexible seals, inwardly-directed so as to be pressed, by air pressure in the cleaning duct, against the tank wall. This axially vertical duct, which has its inlet uppermost and its outlet lowermost, might extend the entire vertical extent of the cylindrical wall portion, in which case, it will require only one revolution around the tank to traverse the whole of the vertical wall section. Or the duct may be shorter, in which case it may traverse the wall by revolving at several different heights above the base.

In either case, the conical base section can be dealt with by a duct which extends from the outlet of the cleaning duct, angled thereto by the cone angle, and extending down to the central outlet of the tank, when against the conical wall. It will, of course, always be against the conical wall in the case where the vertical cleaning duct extends all the way up the vertical tank wall, but only against the conical wall in the lowermost position of the vertical cleaning duct. The conical wall section is thus only traversed when the cleaning head is in its lowermost position. The lowermost end of the angle section of the cleaning head is adapted, again by flexible seals, to sealingly engage the tank outlet.

The cleaning head is carried on a central shaft, which may be permanently mounted in the tank, or introduced whenever cleaning is required, the shaft having a tubular section connected to the inlet to the cleaning head by a radial arm. The shaft is, in turn, connected to a blower arrangement.

For non-circular section tanks, the radial arm can be resiliently telescopically extensible or mounted on a spring loaded vertical axis bearing. In this case, the rate of rotation can be varied so that, in a timed operation, the cleaning head traverses the wall area at a uniform rate.

Large tanks with internal flanging can also be cleaned by self-propelled cleaning heads on flexible air delivery conduits, held to the tank wall surface, or at least vertical and downwardly-facing surfaces, by suction, and steered, as by turnable wheels, under the control of a controller programmed, as by a structured steering scheme to cover all areas (including flanges) of he tank wall, or by a robotic teaching arrangement, which ‘remembers’ a first, manually effected traverse pattern.

The power to move and steer the cleaning heads, and the suction to hold them, where necessary, against the tank wall surface, as well, of course, as the cleaning operation itself, can all be derived from the air supplied through the flexible conduit.

The invention also comprises apparatus adapted to clean the interior walls of a storage tank, comprising a cleaning head supplied with air, and head traversing means for traversing said head over said walls.

The cleaning head may comprise a cleaning duct having an inlet and an outlet and a lateral opening which in use is sealingly arranged against the tank wall, whereby air flowing through the duct flows over and in contact with the tank wall. Sealing may be by flexible seals, which may be strip seals, inwardly directed whereby to be held by cleaning air pressure against the tank wall

A blower arrangement may supply the air to the cleaning head at different pressures and flow rates. Generally speaking, the blower will be capable of supplying the air at a high flow rate, say 5-100 m/s, which will usually strip most loose material, even viscous liquid or paste or cream materials from the tank wall.

The apparatus may be adapted to supply cleansing materials to be carried in the airflow to assist in the removal of more stubborn deposits. Such adaptation may comprise the provision of supplies of cleansing materials, which may include feeders for liquids in the form of droplets, such as water, which may contain a detergent and/or other additives such as disinfectant and antifungal agents, and hopper means for solid particulate material, which will be effective against scale and other solid wall deposits. Such solid particulate material may comprise flint or other stone aggregate, iron shot, glass or plastics material beads or blasting sand.

Swirl means may be provided to swirl the airflow at the inlet to the cleaning duct, whereby to have the effect of throwing the cleansing materials into contact with the tank wall.

The head traversing means may comprise, in a circular cylindrical tank, a rotary arm supplying air to the cleaning head. In a tank with another cross section, such as a polygonal, e.g., octagonal or square section, a rotary arm may be mounted on a spring bearing so as to be capable of reaching parts of the wall at different distances from a central axis.

In large tanks, especially such tanks with internal flanging, a robotic ‘crawler’, held against the wall surface as by suction, created by the air supply to the cleaning head, e.g. by a Coanda effect, can be driven over the surface (including the flange surfaces) using air power, and steered using, again, air power, so as to traverse the cleaning head over the entire surface.

In particular, large oil storage tanks in tank farms and oil refineries may be cleaned using the methods and apparatus of the invention, but in such, and indeed, other cases, the flammable and/or potentially explosive nature of the material contained therein may militate against the use of air, and it will be understood that, when air is referred to herein, other gases may be substituted therefor, such, for example, as nitrogen, carbon dioxide or even superheated steam, provided appropriate pressures can be maintained throughout the system.

Methods and apparatus for cleaning the interior walls of a storage tank according to the invention will now be described with reference to the accompanying drawings, in which:

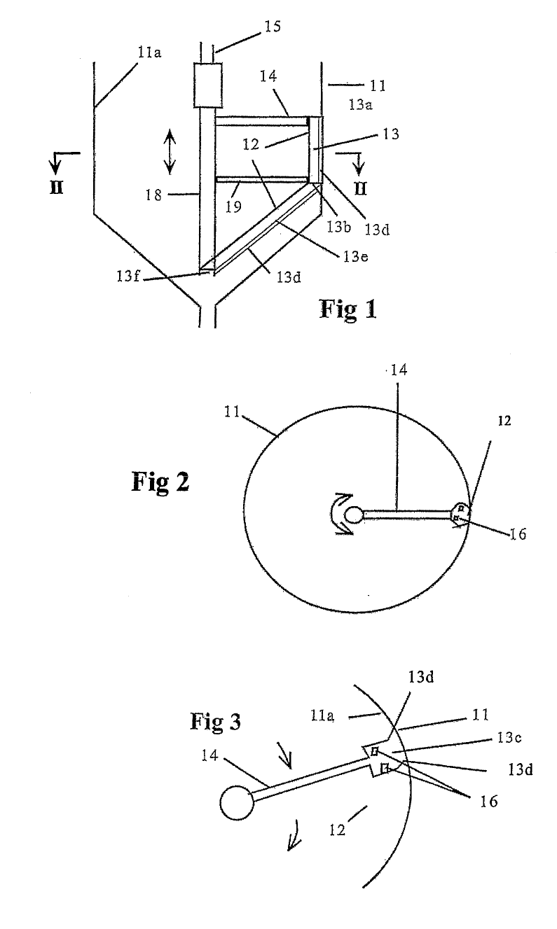

FIG. 1 is a vertical section through an open-topped, conical base tank, with a first embodiment of cleaning apparatus;

FIG. 2 is a cross section on the line II-II of FIG. 1;

FIG. 3 is a partial cross-section, to a larger scale, on the line II-II of FIG. 1 showing, however, a different configuration;

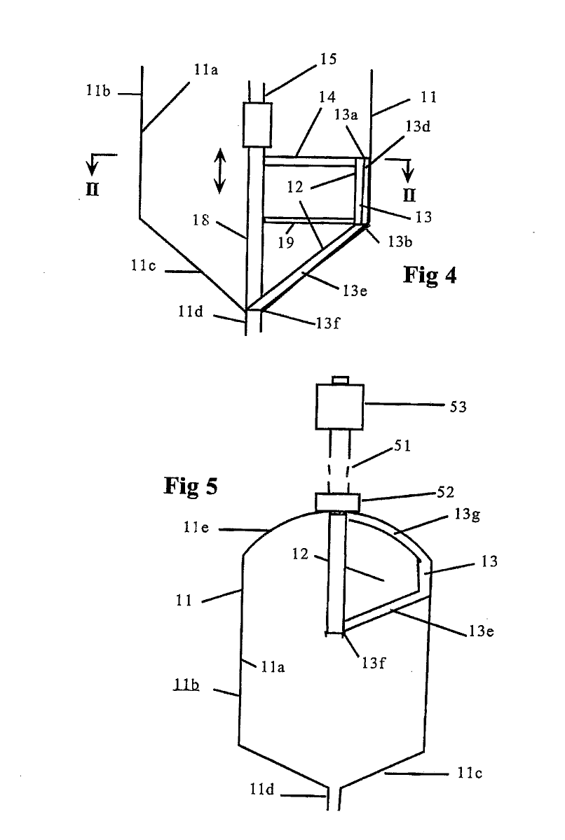

FIG. 4 is a view of the cleaning apparatus in its lowermost position in the tank illustrated in FIG. 1;

FIG. 5 is a cross section, like FIG. 1, of a lidded tank, with a second embodiment of cleaning apparatus;

FIG. 6 is a cross section, like FIG. 1, of a tank with an anchor stirrer and a third embodiment of cleaning apparatus, adapted to such a tank;

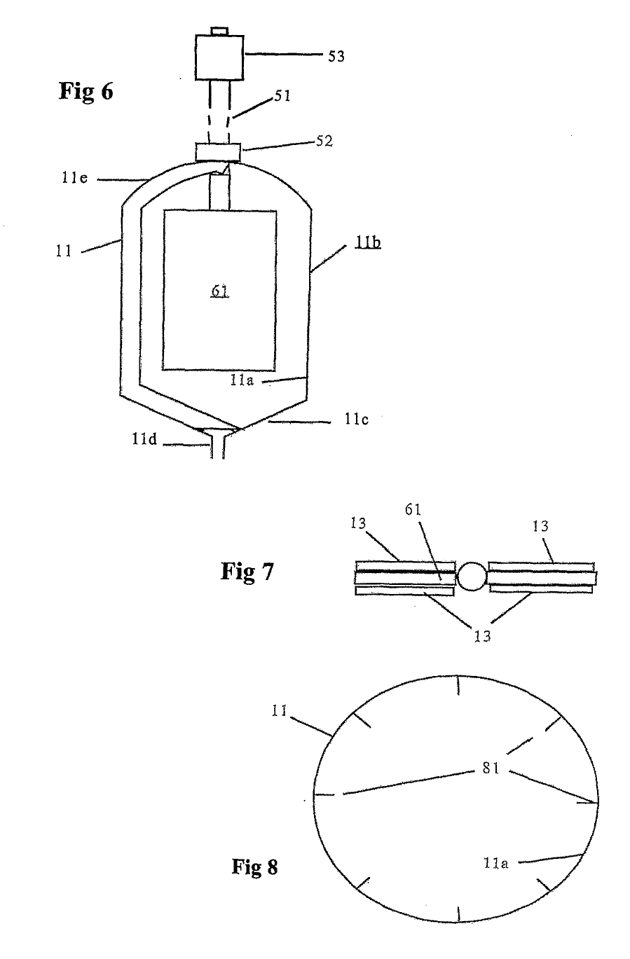

FIG. 7 is a plan view of an anchor stirrer as shown in FIG. 6, with a cleaning arrangement therefor;

FIG. 8 is a horizontal section through a large tank with internal flanges and a fourth embodiment of cleaning apparatus;

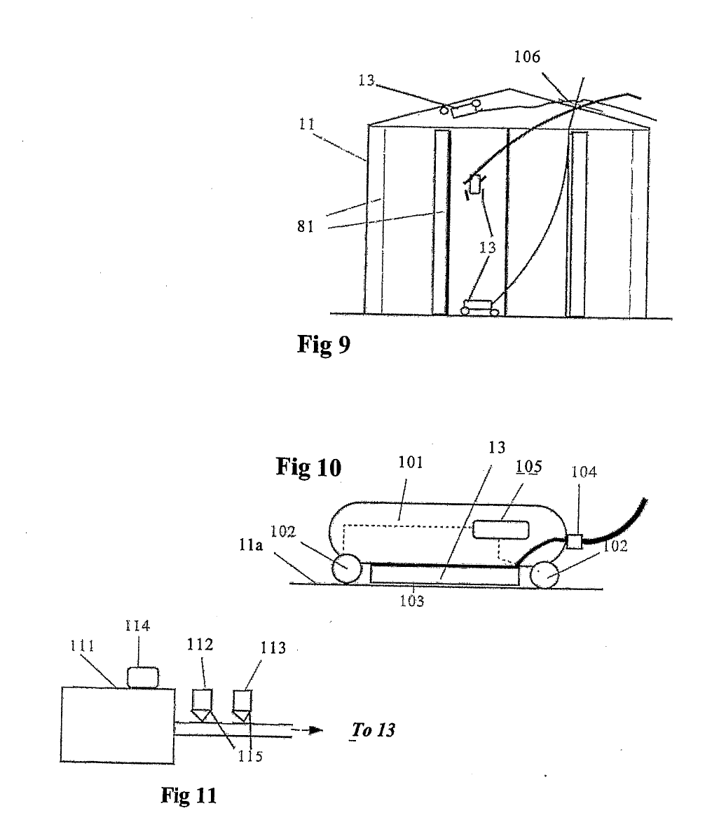

FIG. 9 is a vertical section through the tank of FIG. 10, showing the cleaning apparatus deployed therein;

FIG. 10 is a diagrammatic illustration of a cleaning head of the fourth embodiment of apparatus; and

FIG. 11 is a diagrammatic illustration of the cleaning system blower and cleaning material feed arrangements common to all embodiments.

The drawings illustrate a method for cleaning the interior walls 11a of a storage tank 11, comprising traversing over said walls 11a a cleaning head 12 supplied with air.

The cleaning head 12 comprises a cleaning duct 13 having an inlet 13a and an outlet 13b and a lateral opening 13c which in use is sealingly arranged against the tank wall 11a, whereby air flowing through the duct 13 flows over and in contact with the tank wall 11a. The airflow runs in contact with the tank wall 11a along the lateral opening 13c from inlet 13 a to outlet 13b, and effectively scrubs the wall 11a.

The air can be supplied to the cleaning head 12 at different pressures and flow rates, depending on the nature of the material to be removed from the walls 11a and the current stage of a multi-phase cleaning operation. Generally speaking, air may be supplied at a high flow rate, say 5-100 m/s, which will usually strip most loose material, even viscous liquid or paste or cream materials from the tank wall.

However, cleansing materials may be carried in the airflow to assist in the removal of more stubborn deposits. Such cleansing materials may include liquids in the form of droplets, such as water, which may contain a detergent and/or other additives such as disinfectant and antifungal agents, or organic solvents or chemical cleansers such as acids and alkalis, and solid particulate material, which will be effective against scale and other solid wall deposits. Such solid particulate material may comprise flint or other stone aggregate, iron shot, glass or plastics material beads or blasting sand.

The airflow is swirled at the inlet 13a to the cleaning duct 13, whereby to have the effect of throwing the cleansing materials into contact with the tank wall 11a.

FIG. 1 illustrates an open topped tank 11 having a circular cylindrical wall section 11b and a conical base section 11e, with a lowermost outlet 11d. The cleaning head 12 comprises a duct 13 which is circular cylindrical in cross section, with a lateral opening 13c extending from end to end and provided with edge seals 13d of flexible material such as rubber, and is held against the tank wall 11a in section 11b on a rotary arm 14 which is tubular and which conveys air from an upper connection 15 to the duct 13. Another embodiment of duct 13, with an open-sided square, rather than a circular cylindrical cross section, is shown in FIG. 3. The air flowing through the duct 13 is swirled by swirl vanes 16 at the inlet 13a and passes over the wall section between the seals 13d from inlet 13a to outlet 13b scrubbing the wall and stripping it of material deposited on it.

The length of the duct 13 is less than the vertical extent of the wall section 11b, and, to cover the entire circular cylindrical wall surface 11a of the section 11b, the duct 13 is elevated and lowered on a bearing arrangement 17, and rotated on the arm 14. Any convenient means may be used to effect this traversing movement, but, since air power is available, air motors can be used, and this will be particularly advantageous when the tank contains flammable material and sparks must be avoided.

The air escaping from the outlet 13c simply runs down towards the tank outlet 11d and exits, together with any ejecta, i.e., remove wall deposits and any cleaning material introduced to assist n the cleaning process, from the outlet 11d.

To clean the conical base section 11c, an extension duct 13e is provided, angled with respect to the duct 13, so as to correspond to the cone angle of the base, so that it contacts the base section sealingly, exactly as for the duct 13, when the duct 13 is in its lowermost position. The extension duct 13e has a lowermost seal arrangement 13f which seals against the tank outlet 11d as the arm 14 rotates so that, in this lowermost position seen in FIG. 4, all air passing through the duct 13e and extension duct 13e, together with any ejecta, exits the tank outlet 11d.

A pipe 18 extending downwardly from the upper connection 15 carries a second rotary arm 19 which supplies additional air to the upper end of the inclined duct extension 13c, which is also provided with swirl vanes 16a.

In operation, with the rotary arm 14 in its uppermost position, with the duct 13 set to clean the upper part of the tank wall 11a, the airflow is turned on and the arm 14 rotated so as to traverse the duct 13 around the upper section of the wall 11a of the tank 11. This purely air mode of cleaning can be continued to cover the entire surface area of the tank wall 11a by traversing the arm 14 vertically, so that, eventually, the angled duct extension 13 e contacts, and cleans, the conical section 11c. The operation can be repeated, lifting the rotary arm 14 back up to the top of the tank 11, with the introduction of cleaning material into the airflow, solid material, if there is resistant scale to remove, liquid material if not, or perhaps after a solid material pass. Finally, a wet surface can be dried off using dry or heated air, heating being effected, if desired, by passing in heat exchange with a hot surface, such as an electric resistance heating element, or simply by adiabatic heating, by throttling back an outlet from a blower arrangement, to be further described below.

However, if desired, the solid and/or liquid cleaning mode may follow the purely air mode when the rotary arm 14 is in its uppermost position, then the arm 14 lowered to traverse the next lower section of the tank wall, and all cleaning modes there completed before further lowering of the ann 14, and so on, until the entire tank wall has been dealt with.

FIG. 5 shows a lidded tank 11 with a cleaning head 13 that is generally like that illustrated in FIGS. 1 to 4, but has an upper extension 13g in addition to the lower extension 13e. The upper extension 13g is shaped to conform to the shape of the lid 11e. If the lid 11d is removable, the cleaning head 13 can be mounted on a column 51, extending through a bearing 52 in the lid 11d, driven in rotation by an air motor 53 and raisable and lowerable as by an air ram arrangement.

For non-circular tanks, such as tanks which are hexagonal or elliptical in plan, the cleaning head can be arranged on a telescopically extendable rotary arm, or on a rotary arm that is hinged and spring loaded so as always to remain in contact with the tank wall.

Although, the tanks generally referred to herein are cylindrical, with upstanding walls and a base, the tanks, of course, can be in any orientation, and the invention is also useful for cleaning out road tankers, with appropriate adaptation.

FIG. 6 shows an arrangement adapted for a tank 11 which has an anchor stirrer 61. Here, the head 13 comprising upper and lower portions, 13f, 13e is formed as a unit conforming to the cylindrical wall sector and the lid 11d and base 11c sections. The unit rotates against the wall 11a in the space between the wall and the stirrer 61.

FIG. 7 shows how the anchor stirrer 61 itself can be cleaned. Cleaning heads 13 are shown (without connecting hoses and traverse arrangements, for simplicity's sake) are arranged against the flat faces of the paddles of the stirrer 61, shown here in plan view, to be moved up and down thereover. If, as will often be the case, the cleaning apparatus is permanently located in the tank, it will, itself, need to be cleaned. By providing two cleaning heads, properly configured, it is possible for each to clean the other.

FIG. 8 shows, in horizontal section, a large, circular cylindrical storage tank 11, such as an oil storage tank in a tank farm or refinery, constructed with internal flanges 81. Here, not only the wall surfaces, but also the flange surfaces need to be cleaned, and the cleaning heads need to be designed so as to be able to access all the surfaces. This is achieved, as shown in FIGS. 8, 9 and 10, by making the cleaning heads 13 movable and steerable, on flexible hoses 81 of appropriate length, held against the wall 11 a by suction, or, in the case of ferromagnetic tanks, magnetically, if desired. The cleaning air can, of course, be used for motive and steering power for the cleaning heads 13, control for which can be provided by ultrasonic, infrared or radio communication from a controller which is programmed as by surveying the tanks and planning movements to cover the entire surface to be cleaned, or by a robotic arrangement learning a series of movements first executed manually. The position of cleaning heads 13, of which several may be used at once in a large tank, can be determined by sonic or laser measurement in order to give corrective feedback to a control system. In any event, a cleaning head, shown diagrammatically in FIG. 10, comprises a carriage 101 on steerable drive wheels 102 and having a cleaning duct 103 sealingly held against the wall 11a, with a hose attachment 104 which provides cleaning air (in which cleaning material, liquid and/or solid, can be entrained, as in the other embodiments), as well as motive and steering power through air motors, shown diagrammatically as box 105. Either a single hose connection can be provided, as illustrated, in which case, ejecta will simply fall to the bottom of the tank and be expelled by general airflow from a lowermost tank outlet, or supply and return hoses can be provided, which will remove ejecta through the return hose. Generally, the cleaning apparatus will be introduced, e.g., through an upper access panel 106 into the tank whenever a cleaning operation is required, rather than remain in the tank on a permanent basis, so essentially no provision need be made for cleaning the cleaning apparatus in situ.

In another arrangement, a single air delivery hose may be used, the cleaning heads having separators collecting ejecta in collection chambers, exhausting spent cleaning air into the tank 11.

Where the tank contains flammable material, nitrogen or some other inert gas may be substituted for air, and references to air herein include such other gases. Appropriate measures as regards the construction of the cleaning heads—the use of non-sparking materials, measures against static build-up, and so forth—and their safe operation, will be important in these circumstances.

FIG. 11 shows diagrammatically a blower arrangement 111, together with liquid (112) and solid particulate (113) cleaning material feed arrangements feeding cleaning air to the cleaning heads of each of the embodiments above described. A control arrangement 114 controls valves 115 mediating the flow of the liquid and solid particulate materials into the ducting 115 conveying the air from the blower 111 to the cleaning head 13.

In other embodiments of cleaning apparatus according to the invention, the means of generation of airflow may be integral with the cleaning head, which may include an electric or other motor driven blower.

1. A method for cleaning the interior walls of a storage tank, comprising traversing over said walls a cleaning head supplied with air.

2. A method according to claim 1, in which the cleaning head comprises a cleaning duct having an inlet and an outlet and a lateral opening which in use is sealingly arranged against the tank wall, whereby air flowing through the duct flows over and in contact with the tank wall.

3. A method according to claim 1 or claim 2, in which the air is supplied to the cleaning head at different pressures and flow rates.

4. A method according to any one of claims 1 to 3, in which air is supplied at a high flow rate, say 5-100 m/s, sufficient to strip most loose material, viscous liquid or paste or cream materials from the tank wall.

5. A method according to any one of claims 1 to 4, in which cleansing materials art carried in the airflow to assist in the removal of more stubborn deposits.

6. A method according to claim 5, in which cleansing materials including liquids in the form of droplets, such as water, which may contain a detergent and/or other additives such as disinfectant and antifungal agents are carried in the airflow.

7. A method according to claim 5 or claim 6, in which solid particulate material effective against scale and other solid wall deposits is carried in the airflow.

8. A method according to claim 7, in which such solid particulate material comprises flint or other stone aggregate, iron shot, glass or plastics material beads or blasting sand.

9. A method according to any one of claims 1 to 8, in which the airflow is swirled at the inlet to the cleaning duct, whereby to have the effect of throwing the cleansing materials into contact with the tank wall.

10. A method according to any one of claims 1 to 9, in which the entire tank wall area is traversed several times, each time deploying one phase of the cleaning process.

11. A method according to claim 10, in which a cleaning head is traversed over the entire wall surface, in a first pass, with just air flowing at high speed, stripping off whatever wall deposit it may, then, a second pass is made of the entire wall surface, this time with a cleansing material entrained in the air stream.

12. A method according to any one of claims 1 to 9, in which a cleaning head makes only one pass over the tank wall, pausing while all, or as many as may be desired, operations are effected before moving on to another wall section.

13. A method according to claim 11 or claim 12, in which one phase of the cleansing operation comprises a solid particulate material treatment.

14. A method according to any one of claims 11 to 13, in which one phase of the cleaning operation involves the use of liquid cleansers such as water with detergent or an organic solvent or a chemical cleanser such as an acid or alkali.

15. A method according to any one of claims 1 to 14, in which dry air is passed through the cleaning head, to dry off a wet wall surface after a liquid treatment.

16. A method according to claim 14, in which the air is heated, as by a electric resistance heating, or by adiabatic heating by throttling back the outlet from a blower supplying the air, or by throttling back the outlet of the cleaning head duct, whereby to increase pressure, and hence temperature.

17. A method according to any one of claims 11 to 16, in which the mode of operation is a hybrid of the methods of claims 11 and 12.

18. A method according to any one of claims 1 to 17, in which the entire operation, or one or more sections of it, is or are effected automatically.

19. A method according to claim 18, carried out under the control of a process controller.

20. A method according to claim 18 or claim 19, in which different parts of the operation are carried out on a sequential, timed, basis.

21. A method according to any on of claims 18 to 20, in which the operation is carried out in response to sensor means detecting when any particular stage of the operation is completed.

22. A method according to claim 21, in which the completion of scale removal is indicated by a sensor detecting a cessation of fine scale dust in the airflow.

23. A method according to claim 21 or claim 22, in which the completion of drying is indicated by a relative humidity sensor.

24. Apparatus for cleaning the interior walls of a storage tank, comprising a cleaning head supplied with cleaning airflow and means for traversing said cleaning head over said walls.

25. Apparatus according to claim 24, in which the air passes through the cleaning head so as to travel along and in contact with the wall surface.

26. Apparatus according to claim 25, in which the cleaning head comprises a cleaning duct through which the air passes from an inlet to and an outlet from the duct.

27. Apparatus according to claim 26, in which the duct comprises a channel section having edgewise-disposed seals which in use contact the tank wall.

28. Apparatus according to any one of claims 24 to 27, having swirl means to swirl air in the cleaning head.

29. Apparatus according to claim 28, said swirl means comprising swirl vanes at an air inlet to the cleaning head.

30. Apparatus according to any one of claims 24 to 29, adapted for a circular cylindrical tank, in which the cleaning head is traversed over the wall surface by rotation about the axis of the tank.

31. Apparatus according to any one of claims 24 to 30, in which the cleaning head is traversed vertically over the wall of the tank.

32. Apparatus according to any one of claims 24 to 31, adapted for an open top, circular-cylindrical tank with a conical base having a central, lowermost outlet, in which the cleaning head comprises a cylindrical duct adapted to be disposed against the tank wall, axially parallel thereto and sealed thereagainst by flexible seals, inwardly-directed so as to be pressed, by air pressure in the cleaning duct, against the tank wall.

33. Apparatus according to claim 32, in which said duct, which has its inlet uppermost and its outlet lowermost, extends the entire vertical extent of the cylindrical wall portion, requiring only one revolution around the tank to traverse the whole of the vertical wall section.

34. Apparatus according to claim 32, in which said duct is shorter than the vertical wall portion, and traverses the wall by revolving at several different heights above the base.

34. Apparatus according to and one of claims 32 to 34, comprising a duct which extends from the outlet of the said duct, angled thereto by the cone angle, and extending down to the central outlet of the tank, when against the conical wall.

35. Apparatus according to claim 34, in which the lowermost end of the angle section of the cleaning head is adapted, by flexible seals, to sealingly engage the tank outlet.

36. Apparatus according to any one of claims 32 to 35, in which the cleaning head is carried on a central shaft.

37. Apparatus according to claim 36, in which the central shaft is permanently mounted in the tank.

38. Apparatus according to claim 36, in which the central shaft is introduced whenever cleaning is required.

39. Apparatus according to any one of claims 36 to 38, the central shaft having a tubular section connected to the inlet to the cleaning head by a radial arm.

40. Apparatus according to any one of claims 36 to 39, in which the central shaft is connected to a blower arrangement.

41. Apparatus according to any one of claims 24 to 31, adapted for non-circular section tanks, in which a radial arm carrying a cleaning head is resiliently telescopically extensible, so as to extend and contract as it is rotated in the tank to accommodate wall sections at different radii from it rotary axis.

42. Apparatus according to any one of claims 24 to 31, in which a rigid radial arm carrying a cleaning head is mounted on a spring loaded vertical axis bearing, whereby to adjust its orientation so as always to keep the cleaning head in operative position against the tank wall during rotation.

43. Apparatus according to claim 41 or claim 42, in which the rate of rotation is varied so that, in a timed operation, the cleaning head traverses the wall area at a uniform rate.

44. Apparatus according to any one of claims 24 to 43, adapted for large tanks with internal flanging, comprising self-propelled cleaning heads on flexible air delivery conduits, held to the tank wall surface, or at least vertical and downwardly-facing surfaces, by suction, and steered, as by turnable wheels, under the control of a controller programmed, as by a structured steering scheme to cover all areas (including flanges) of he tank wall, or by a robotic teaching arrangement, which ‘remembers’ a first, manually effected traverse pattern.

45. Apparatus according to any one of claims 24 to 44, in which the cleaning head comprises airflow generation means generating a flow of cleaning air.

46. Apparatus according to claim 45, in which the airflow generation means comprise a motor driven blower arrangement.
